(19) United States
(12) Patent Application Publication
(10) Pub. No.: US 2024/0199105 A1
(43) Pub. Date: Jun. 20, 2024

(54) MULTI FUNCTION, MULTIPLE CHILD NESTING SHOPPING CART EXTENSION AND METHOD OF USE

(71) Applicant: Jeanine McINTOSH, Spruce Grove (CA)

(72) Inventor: Jeanine McINTOSH, Spruce Grove (CA)

(21) Appl. No.: 18/084,037

(22) Filed: Dec. 19, 2022

(51) Int. Cl. B62B 3/14; B62B 5/08

(52) U.S. Cl. CPC B62B 3/1444; B62B 3/1452; B62B 3/1492; B62B 5/082; B62B 5/087; B62B 2501/00

(57) ABSTRACT

There is disclosed a multiple child shopping cart extension for attachment to a shopping cart frame. The multiple child shopping cart extension may be used to make an extended shopping cart, for carrying additional children in a shopping cart, both standing and sitting. The multiple child shopping cart extension preferably comprises a frame structure and a plurality of frame securing elements, for securing said multiple child shopping cart extension to said shopping cart frame. The frame structure preferably comprises a base unit and two side rail portions, affixed at opposing sides of the base unit at a bottom end of said frame structure. The multiple child shopping cart extension may also have a seat unit and a safety strap.

### BACKGROUND

### Field of the Invention

The present invention relates generally to the field of carts, and more specifically to an extension to shopping carts for carrying two or more children.

### Background

Presently, shopping centers offer “car” shopping carts, where a child rides in a car on a front end of a cart but they are typically large and awkward.

Also available are attachments which provide two seats at a back end of a cart, up high, but a shopping center may only carry a few. Furthermore, they are generally too small for older children—for example, children older than four.

Any discussion of the related art throughout the specification should in no way be considered as an admission that such related art is widely known or forms part of common general knowledge in the field.

CA 2237287 discloses a shopping basket and child carrier cart assembly providing a stable and lower positioned child carrier. The assembly has a cart with a lower frame and a basket chamber, the frame having a plurality of front casters and a plurality of rear casters secured to the bottom of the frame adapted for mobility of the cart upon the casters. The basket has a central chamber defined by basket walls, with a hinged basket rear wall adapted to open to provide a rear opening for receiving a basket of a second cart for stacking such carts. The assembly has a child carrier with a generally horizontal seat platform secured to the cart by a brace member extending outward of the rear wall of the basket chamber, in a position below the rear opening. The assembly further provides an expanded wheel base length of the cart for the rear casters positioned below the child carrier, and provides a safety harness removably secured to the seat platform. This design only allows for one sitting child in the cart; it does not accommodate more than one child, and it does not allow for an older child to stand in the cart.

U.S. Pat. No. 5,961,133 discloses a portable child-carrying shopping cart having a collapsible cart basket. The cart has a seat for two small children and seat belts for keeping children safely seated side-by-side. An extendable snack tray provides children with access to their own snacks and beverages, so that a parent does not have to maintain constant control of these items. Below the seat is an interior cavity with a coat hook and a space for storing bags, purses, and garments. On the opposing side of the body of the device, a cart basket is secured. The cart basket is expandable and collapsible. The device can be easily stowed when the basket is collapsed against the body. It can also be quickly expanded for use as a shopping cart when a parent is running errands. This design only accommodates sitting children, and positions the children in the front of the shopping cart, which is disadvantageous to a parent who may need to reach their children.

CA 1073495 discloses a shopping cart having a novel locking arrangement for the gate of the upper basket and featuring a baby basket that seats a child below the level of the upper basket for enhanced stability of the cart and economy of storage in the upper basket, as well as to position and face the child towards the mother who is pushing the cart so that the child cannot reach or kick the gate or the groceries in the upper basket. The novel locking arrangement for the gate includes a latch plate having an end restraining shield that provides an abutment stop for limiting the forward movement of the gate unless the gate is manually lifted and opened. The gate has ears which prevent the gate from falling into the interior of the basket, and has at least one pin that engages the end restraining shield. Auxiliary side walls are mounted above the sides of the baby basket to prevent the child from reaching items on the shelves of the store and to protect the child from the corners of shelves and from being accidentally struck by other carts. The rear wall of the upper basket is positioned above the back support of the baby basket to assist in supporting the back of the child. The shopping cart also features side handles extending above the auxiliary side walls for improved maneuverability and for eliminating the conventional crossbar-type handle to remove the possibility of the child bumping his forehead on such a handle. This design only allows for one sitting child in the cart; it does not accommodate more than one child, and it does not allow for an older child to stand in the cart.

CA 2770917 discloses a cart including a push handle moveable from a first position to a second position; and a chair which further includes (i) a seat facing the push handle, the seat further comprising an abduction block; (ii) a safety belt; (iii) a backrest extending upwardly from the seat; and (iv) a foot rest and one or more wheels. In another aspect, a shopping cart suitable for carrying a special needs rider is provided including a generally rectangular cargo basket, four swiveling wheels, a chair further comprising: a rearwardly facing seat further comprising an abduction block, said seat inclined at approximately a five degree angle from a horizontal axis downwardly toward a backrest, which backrest extends generally upward from the seat and is reclined at approximately a five degree angle from a vertical axis, a five point restraint safety belt and a foot rest positioned to support the rider's feet when positioned in the seat; one or more push handle moveable from a first position to a second position by pivoting around a roughly horizontal axis; and two load bearing wheels positioned substantially in the same vertical plane as the rider. This design only allows for one child, and does not accommodate standing children.

U.S. Pat. No. 6,572,122 discloses a multiple child seat nestable shopping cart is provided with a wheeled chassis and a seating module. The seating module includes front and rear wheels and at least two seats facing inwardly towards each other and positioned behind a rear portion of the shopping cart basket. The seats are positioned, dimensioned and configured so as to receive a front nesting portion of another cart basket over the at least two seats when unoccupied. This design does not accommodate standing children.

US 20140232088 discloses a folding and combined shopping cart/stroller includes a four-wheeled cross-shaped frame that carries a box-shaped basket and a child seat, thereby creating a functionally designed rigs for manual transportation of goods. The raised platform is positioned above and fixed to the shaft and hang between the front and trailing arms. The basket can be changed to half volume and thus can form a child's seat used in the front of the cart. This design only accommodates sitting children, and positions the children in the front of the shopping cart, which is disadvantageous to a parent who may need to reach their children.

JP 2014201243 discloses a shopping cart having mobility in which an adult including an elderly person, and a child can be seated easily without spoiling the pleasure of shopping. The shopping cart includes: a mounting part 2 composed of right and left side walls 3 and 4, a bottom wall 5, and front and rear gates 6 and 7, and a middle gate 8 provided between the right and left side walls 3 and 4; a support part 9 for supporting the mounting part 2; a plurality of casters 11 attached to the lower part of the support part 9; and a holding part 12 provided on the rear side of the mounting part 2. In the mounting part 2, the part between the front gate 6 and the middle gate 8 is a seat part 2A used by an adult or a child, and the rear side is a shopping basket placing part 2B for placing a shopping basket B. This design only accommodates one seated user at a time.

All documents cited herein are incorporated by reference.

There is a need for a multi function, multiple child, shopping cart, for carrying more than one child of various ages and sizes. There is also a need for this shopping cart to be nestable, and compatible with traditional shopping carts, such that a store or shopping center may store them with ease and have many available for their customers.

None of the above cited documents, alone or in combination satisfy the need for a multi function, multiple child, nesting cart that addresses the above-mentioned deficiencies.

### BRIEF SUMMARY

It is an object of the invention to provide a multi function, multiple child, nesting cart extension for extending a shopping cart to have seating and standing room for more than one child, while allowing the shopping cart to nest with traditional shopping carts.

By taking a traditional shopping cart and adding an extension with an elongated handle and a base, the cart can carry a standing child without putting the child in danger and with no awkward weight.

According to an aspect of the invention, there is disclosed a multiple child shopping cart extension for attachment to a shopping cart frame, comprising a frame structure having a base unit at a bottom end and two side rail portions, affixed to opposing sides of said base unit, each of said side rail portions having a vertical rail portion, located on an outer side of said frame structure, extending from said bottom end to a top end, and one or more transverse rail portions, said transverse rail portions extending from said outer side to an inner side of said frame structure, said one or more transverse rail portions being affixed to said vertical rail portion; and, a plurality of frame securing elements, for securing said multiple child shopping cart extension to said shopping cart frame, wherein said plurality of frame securing elements attach each of the said vertical rail portions to a rear end of said shopping cart frame.

According to another aspect of the invention, there is provided a method of assembling an extended shopping cart with the multiple child shopping cart extension, the method comprising securing, with the frame securing elements, the multiple child shopping cart extension to the shopping cart frame.

According to an aspect of an embodiment of the invention, there is provided a kit for assembling an extended shopping cart with the multiple child shopping cart extension, the kit comprising: the frame securing elements, the multiple child shopping cart extension, and two or more wheel members.

According to an aspect of an embodiment of the invention, the multiple child shopping cart extension may further comprise a safety strap.

According to an aspect of an embodiment of the invention, the multiple child shopping cart extension may further comprise a seat unit, positioned on a slide out c-channel track.

The advantages and features of the present invention will become better understood with reference to the following more detailed description and claims taken in conjunction with the accompanying drawings in which like elements are identified with like symbols.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1 illustrates a side view of an aspect of the subject matter in accordance with one embodiment.

FIG. 2 illustrates a 2 dimensional top-down view of several aspects of the subject matter in accordance with one embodiment of the invention.

FIG. 3A illustrates a perspective view of an aspect of the subject matter in accordance with one embodiment.

FIG. 3B illustrates a perspective view of an aspect of the subject matter in accordance with one embodiment.

FIG. 4 illustrates a perspective view of an aspect of the subject matter in accordance with one embodiment.

FIG. 5 illustrates side views of the subject matter in accordance with two embodiments.

FIG. 6 illustrates an aspect of the subject matter in accordance with one embodiment.

FIG. 7 illustrates a perspective view of an aspect of the subject matter in accordance with one embodiment.

FIG. 8 illustrates an aspect of the subject matter in accordance with one embodiment.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

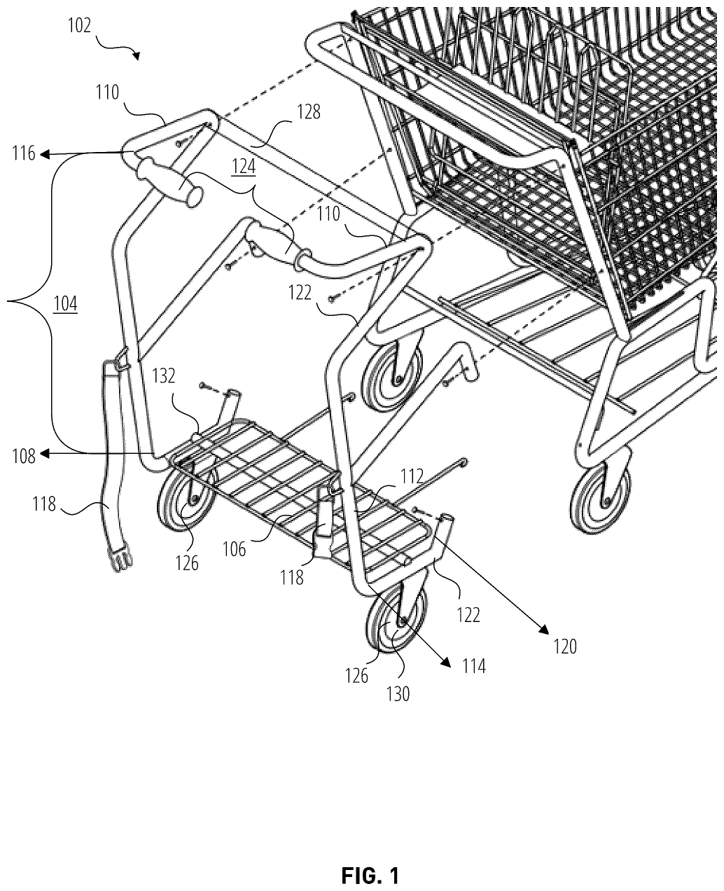

FIG. 1 illustrates a multiple child shopping cart extension 102, having a frame structure 104 comprising: a base unit 106 at a bottom end 108 of the frame structure 104 and two side rail portions 110, which are permanently or removably affixed at opposing sides of the base unit 106.

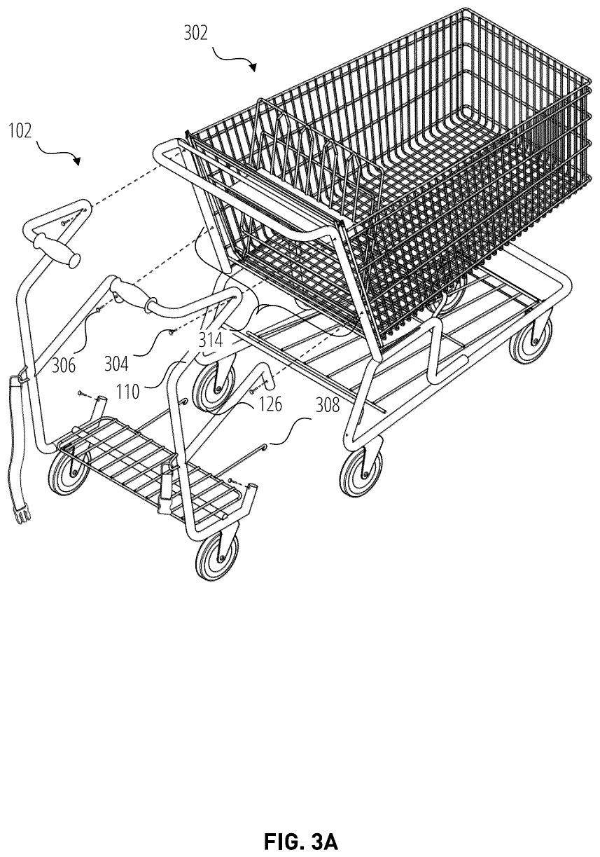

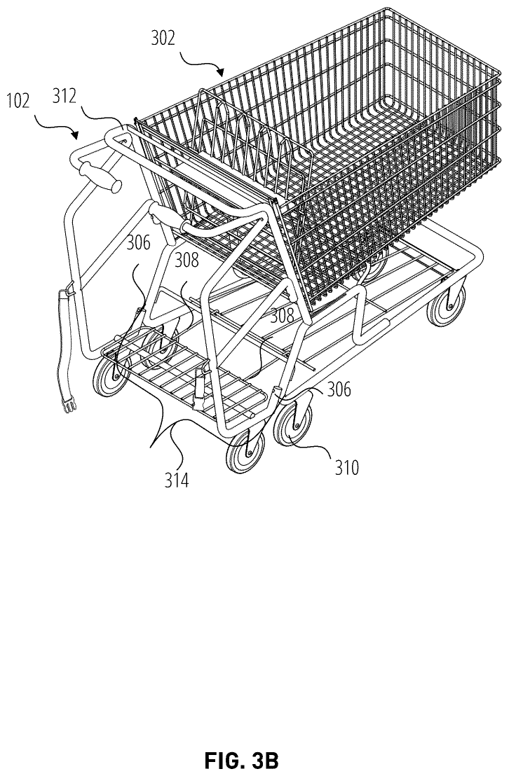

The frame structure 104 is preferably, but not necessarily, a solid piece, except for the base unit 106, attached at the bottom end 108 to a transverse rail portion 122 by a releasable attachment 132, such that the base unit 106 may lift up from the frame structure 104 towards a top end 116 for facilitating nesting with a shopping cart. The releasable attachment 132, may be, for example, a hinge attachment, clips, magnets, and the like. Alternatively, the base unit 106 may not be physically attached to the transverse rail portion 122, but hooked on to a shopping cart frame (as shown in FIG. 3), to permit lifting up the base unit 106.

Each of the side rail portions 110 preferably comprise a vertical rail portion 112, located on an outer side 114 of the frame structure 104, extending from said bottom end 108 to a top end 116, one or more transverse rail portions 122, said transverse rail portions 122 extending from said outer side 114 to an inner side 120 of said frame structure 104

The one or more transverse rail portions 122 are preferably connected to said vertical rail portions 112.

In one embodiment, said side rail portions 110 further comprise a pair of handle members 124, each handle member 210 being permanently affixed to each of the side rail portions 110 at the top end 116, and said pair of handle members 124 extending from said inner side 120 towards said outer side 114.

Preferably, the side rail portions 110 are connected at the top end 116, on the inner side 120 by an upper horizontal rail portion 128. This is particularly important when the multiple child shopping cart extension 102 is to stand alone. Without the upper horizontal rail portion 128, the multiple child shopping cart extension 102 can typically stand only if it is attached to a shopping cart frame.

In one embodiment, the multiple child shopping cart extension 102 further comprises at least two wheel members 126, affixed to the frame structure 104 at the bottom end 108, which allows for added stability of the multiple child shopping cart extension 102. The wheel members 126 may have a fixed axle 130 or they may have a steering axle 130.

In another embodiment, the multiple child shopping cart extension 102 may preferably comprise a safety strap 118 which may be releasably attached to one side rail portion 110 and to another side rail portion 110.

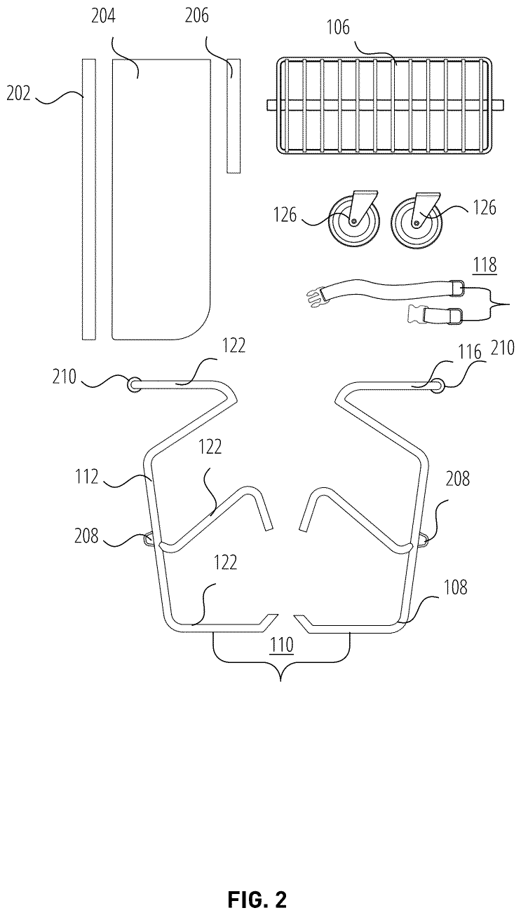

FIG. 2 illustrates a two dimensional view of a deconstructed multiple child shopping cart extension 102 according to one embodiment.

Each of the two side rail portions 110 comprise a vertical rail portion 112 and one or more transverse rail portions 122.

The one or more transverse rail portions 122 are preferably connected to said vertical rail portions 112. In the embodiment illustrated herein, there are three transverse rail portions 122, spaced out along the vertical rail portion 112, with one at the bottom end 108, one at the top end 116, and one in between the bottom end 108 and the top end 116.

In one embodiment, the side rail portions 110 further comprise a pair of handle members 124, each handle member 210 being permanently affixed to each of the side rail portions 110 at the top end 116, and said pair of handle members 124 extending from said inner side 120 towards said outer side 114.

A connection area 208 allows the safety strap 118 to attach to either of the side rail portions 110. The safety strap 118 may be located at various heights along the side rail portions 110, and may be adjustable in length.

Wheel members 126 preferably attach, through a permanent attachment or releasable attachment, either to the bottom end 108 of the side rail portions 110, or to the base unit 106.

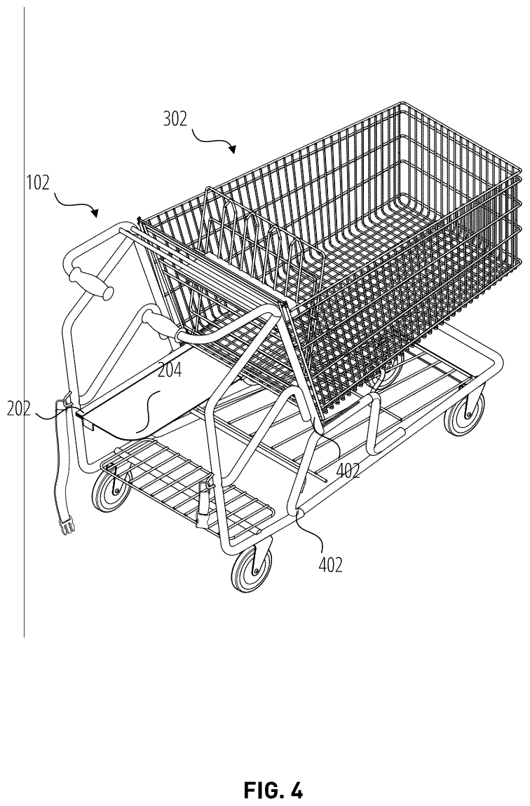

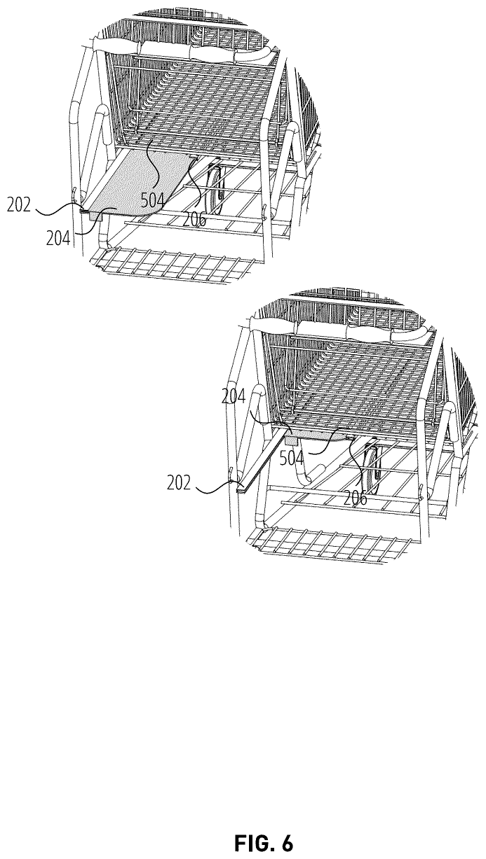

In an alternate embodiment, there may be provided an optional seat unit 204, positioned on a slide-out c-channel track comprising a long c-channel track 202 and a short c-channel track 206. Each of the c-channel tracks 202 and 206 are preferably attached to a shopping cart frame 302, and the seat unit 204 may slide in and out on the c-channel tracks 202, 204. This is depicted in greater detail in FIG. 4 and FIG. 6.

FIG. 3A depicts a multiple child shopping cart extension 102 for use with a shopping cart frame 302.

There may be provided a method of securing the multiple child shopping cart extension 102 to the shopping cart frame 302 with frame securing elements 304.

There may preferably be provided a method of assembling an extended shopping cart, by securing the multiple child shopping cart extension 102 to the shopping cart frame 302 with frame securing elements 304, for example, but not by way of limitation, releasable frame securing elements: frame securing element-hook 308, frame securing element-bolt 306 as shown in FIG. 3A. Releasable securing elements may also include nuts, screws, or other releasable securing mechanisms known in the art. In other embodiments, such as that shown in FIG. 6, the frame securing elements may be permanent 402.

There may preferably be provided a kit for assembling an extended shopping cart, which comprises the elements shown in FIG. 3A, such as the frame securing elements 306, 308, 402, or similar, and the multiple child shopping cart extension 102, and preferably, but not necessarily, the seat unit 204 (not shown here).

Preferably, the frame securing elements-hooks 308, are attached to the base unit 106, on the inner side 120, such that the base unit 106 may attach to the shopping cart frame 302.

A user, such as a shopping cart manufacturer, or a grocery store owner, could assemble an extended shopping cart using the provided kit and their existing shopping cart frames 302. When nesting with another cart, it may be preferable to lift the base unit 106 upwards from the shopping cart frame 302.

Methods of securing the multiple child shopping cart extension 102 to shopping cart frames 302 may comprise releasable attachment mechanisms such as drilling, screwing bolts or screws and nuts, tying zip ties, attaching hooks, and other releasable attachment mechanisms known in the art.

Alternatively, methods of securing the multiple child shopping cart extension 102 to shopping cart frames 302 may comprise permanent attachment mechanisms, such as welding, adhesives, snap-fits, or other permanent securing methods known in the art.

FIG. 3B illustrates an assembled extended shopping cart, wherein the multiple child shopping cart extension 102 is releasably secured to the shopping cart frame 302 with releasable frame securing elements 306, 308 (in this case nuts/bolts and hooks, respectively).

The multiple child shopping cart extension 102 is preferably secured to the shopping cart frame 302 at a rear end 314 of the shopping cart frame 302.

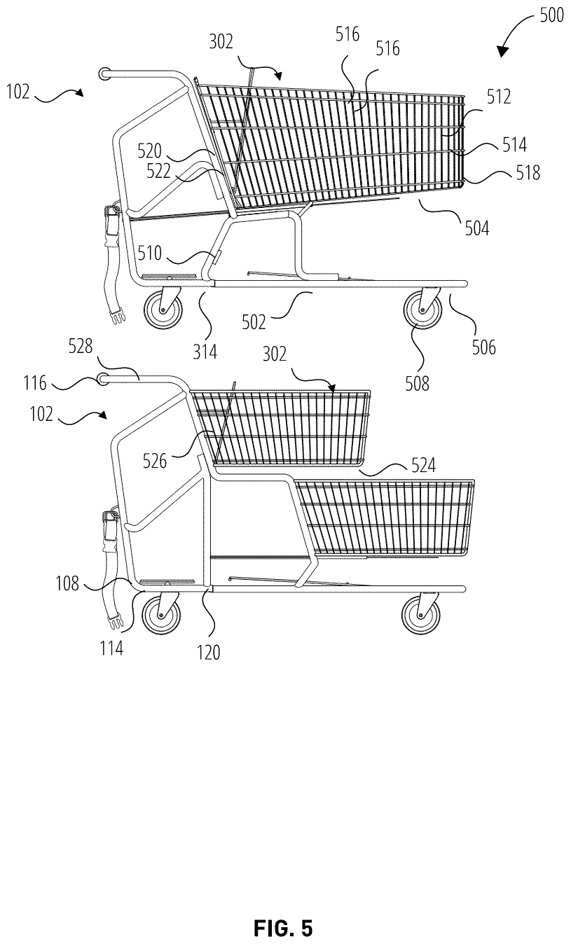

The existing features of the shopping cart frame 302 that are duplicated by the multiple child shopping cart extension 102, for example the rear wheels 310 and the shopping cart handle 312, may be left on the shopping cart frame 302 for a simple extension of the shopping cart frame 302, as shown in FIG. 3A and FIG. 3B. Alternatively, they may be removed, as shown in FIG. 5 as they are redundant with the wheel member 126 and the handle members 210. The wheel members 126 are preferably located under the base unit 106 of the multiple child shopping cart extension 102 to provide stability to the entire extended shopping cart 500, even when there is additional weight on the base unit 106. The pair of handle members 124 is extended towards the outer side 114 so that a parent or user pushing the cart need not lean over children positioned on the multiple child shopping cart extension 102.

FIG. 4 illustrates an assembled extended shopping cart, wherein the multiple child shopping cart extension 102 is permanently secured to the shopping cart frame 302 with frame securing elements—permanent 402. For example, the multiple child shopping cart extension 102 may be welded to the shopping cart frame 302 at the rear end 314.

Also shown in this embodiment is the seat unit 204. The long c-channel track 202 extends outwards from the shopping cart frame 302. The short c-channel track 206 cannot be seen from this view but is preferably also positioned on the shopping cart frame 302. The seat unit 204 can slide outwards from the shopping cart frame 302, stabilized by the c-channel tracks 202, 206.

The c-channel tracks 202, 206, may preferably be attached to the shopping cart frame 302 permanently, by way of welding or similar, or by releasable attachment measures, such as, but not limited to, zip ties.

FIG. 5 illustrates two alternative embodiments of an extended shopping cart 500.

The extended shopping cart 500, which comprises a multiple child shopping cart extension 102, a shopping cart frame 302, and frame securing elements—permanent 402 (not shown), the shopping cart frame 302 preferably comprising a wheeled undercarriage 502 comprising a front end 506 and a rear end 314, a pair of wheels 508 on opposing sides of said front end 506, and a pair of rear frame rail portions 510 projecting upwardly from the rear end 314 of the wheeled undercarriage 502. Generally, the pair of rear frame rail portions 510 extend from the bottom end 108 to the top end 116.

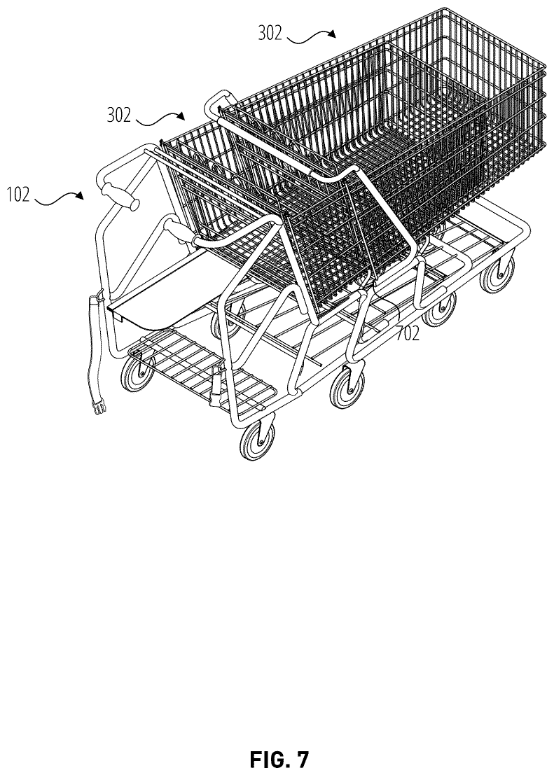

The shopping cart frame preferably further comprises a basket portion 512 having a generally horizontal bottom surface 504, two generally opposed side walls 516, a generally vertical front wall 518, a generally vertical rear wall 520 hingeably secured 522 in position and adapted to rotate about said hingeable attachment 522 to permit nesting (shown in FIG. 7) with a like cart structure within said basket portion 512.

The generally vertical rear wall 520 is preferably secured to said pair of rear frame rail portions 510, the basket portion 512 extending forwardly from the rear frame rail portions at a spacing above said wheeled undercarriage 502.

The side rail portions may comprise a pair of handle members 528, each of the pair of handle members being affixed to each of the side rail portions at the top end 116, and said pair of handle members extending from the inner side 120 towards the outer side 114.

The shopping cart frame preferably comprises one or more child seats 526, mounted on said generally vertical rear wall 520.

The basket portion 512 may be a one tier basket portion 514 or a two tier basket portion 524 or similar.

The multiple child shopping cart extension 102 may be readily attached, either permanently or releasably, to most commercially available carts, whether they be steel or plastic, and regardless of their size or width.

An extended shopping cart 500 may be constructed as a unitary structure as shown in FIG. 5, for example by welding the multiple child shopping cart extension 102 to the shopping cart frame 302. Preferably, the frame securing elements connect each of the vertical rail portions 112 of the extension 102 to each of the pair of rear frame rail portions 510 of the shopping cart frame 302.

The extended shopping cart 500 may comprise the seat unit 204, positioned on a slide-out c-channel track (not shown here), which would attach to the generally horizontal bottom surface 504 of the basket portion 512. The seat unit is preferably configured to slide on the c-channel track, towards the outer side 114.

FIG. 6 illustrates in more detail the slide out seat unit 204. The long c-channel track 202 and the short c-channel track 206 are preferably attached to the generally horizontal bottom surface 504 of the shopping cart frame 302, such that the seat unit 204 may slide outwards, for example when a child is to sit on it, or may be tucked back, so that it is not in the way when not in use.

The long c-channel track 202 preferably extends out past the generally horizontal bottom surface 504, while the short c-channel track 206 preferably extends down the generally horizontal bottom surface 504.

The two c-channel tracks 202, 206, provide stability for the seat unit 204.

The seat unit 204 may also be provided without c-channel tracks 202, 206, and instead may be directly attached to the shopping cart frame 302, however the seat unit 204 would not slide in and out in that case.

FIG. 7 illustrates nesting 702, where an extended shopping cart 500 may nest in another shopping cart frame 302.

A shopping cart frames 302 with the extension may also “stack” or nest 702 with other carts with ease so that extended carts do not take up extra space, allowing stores to house as many as possible.

It may be preferable to lift up the base unit 106 to more easily accommodate nesting 702.

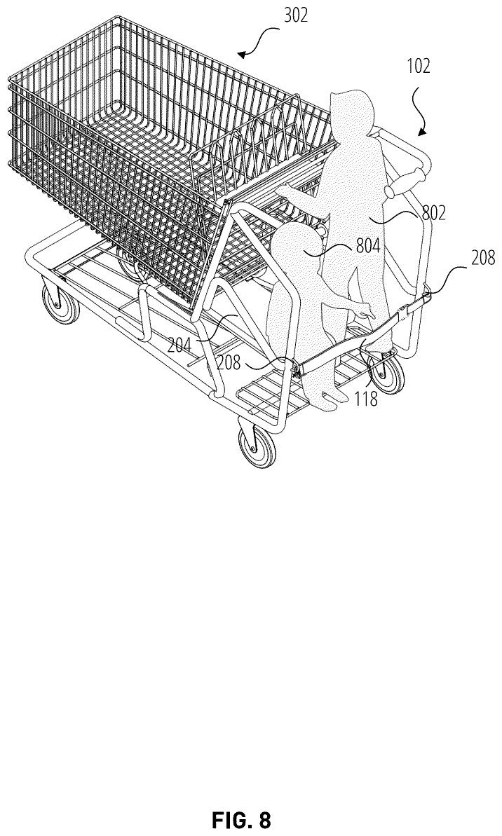

FIG. 8 illustrates an extended shopping cart 500 in use. A standing child 802 child may stand on the base unit 106 of the multiple child shopping cart extension 102, while a sitting child 804 may sit on the seat unit 204 of the multiple child shopping cart extension 102. The safety strap 118 may be connected to the multiple child shopping cart extension 102 at connection areas 208.

The standing child preferably leans against the shopping cart frame 302.

The safety strap 118 may be positioned at varying heights, or removed entirely.

Alternatively, large or bulky items may be stored on the base unit 106, if there are no children using the multiple child shopping cart extension 102.

By altering a shopping cart frame 302 to include a multiple child shopping cart extension 102 a child who is too big for a baby seat, may stand in a safe place so that a parent can accomplish their shopping without confining their child inside the cart or keeping track of them while they are outside the cart.

An older child in a standing position may be in a safer and more stable position than if they were seated in a child seat 526 in a traditional cart.

The multiple child shopping cart extension 102 alters traditional carts by extending the handle and adding a base, so that a cart can carry extra and older children without putting the children in danger and with no awkward weight interfering with the use of the cart.

One, and up to at least two additional children may use the multiple child shopping cart extension 102, for example two standing children, or one standing child 802 and one sitting child 804 as depicted in FIG. 8. Depending on the ages of the children and the size or width of the multiple child shopping cart extension 102, more children may be able to use the multiple child shopping cart extension 102.

Consumers can preferably spend more time and money shopping, as their children are safely positioned within the cart, without being able to tip out of a traditional child seat 526.

Preferably, but not necessarily, the materials used to make the multiple child shopping cart extension are similar to materials already used in shopping cart manufacturing today, for example steel, stainless steel, galvanized steel, hard plastic, and other sturdy, water proof and non-rusting materials that need not necessarily be steel.

Preferably, but not necessarily, the seat unit is made from steel, however alternate materials of a hard, stable structure may be used, including other metals, plastics, and similar.

The multiple child shopping cart extension 102 may either be added to an existing shopping cart frame 302 without modifying it, or the shopping cart frame 302 may be modified to accommodate additional children. For example, it may be preferable to move the existing child seat 526 over to a side of the shopping cart frame 302 such that a child may sit in the child seat 526 and a child may sit in the slide out seat unit 204. A standing child 802 would stand in front of the moved child seat 526.

There may be provided a multiple child shopping cart extension, wheels, safety straps, and a seat unit, such that a manufacturer or store may add the extension to their existing carts.

Alternatively, it may be preferable to manufacture or construct an extended shopping cart as a unitary structure such that the entire extended shopping cart may be sold.

Additionally, it may be obvious to one skilled in the art that the present invention may comprise safety warnings on any of the individual parts, whether they be printed on during manufacturing, or stamped on after manufacturing. For example, it may be preferable to print or stamp “do not stand” or a weight limit on the seat unit 204.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A multiple child shopping cart extension for attachment to a shopping cart frame, comprising:
a frame structure having a base unit at a bottom end and two side rail portions, affixed to opposing sides of said base unit;
each of said side rail portions having a vertical rail portion, located on an outer side of said frame structure, extending from said bottom end to a top end, and one or more transverse rail portions, said transverse rail portions extending from said outer side to an inner side of said frame structure, said one or more transverse rail portions being affixed to said vertical rail portion;
and,
a plurality of frame securing elements, for securing said multiple child shopping cart extension to said shopping cart frame, wherein said plurality of frame securing elements attach each of the said vertical rail portions to a rear end of said shopping cart frame.

2. The multiple child shopping cart extension of claim 1, wherein said plurality of frame securing elements are releasable frame securing elements, for releasably securing said multiple child shopping cart extension to said shopping cart frame.

3. The multiple child shopping cart extension of claim 1, wherein said plurality of frame securing elements are permanent, for permanently securing said multiple child shopping cart extension to said shopping cart frame.

4. The multiple child shopping cart extension of claim 1, said side rail portions further comprising a pair of handle members, each handle member being permanently affixed to each of the side rail portions at the top end, and said pair of handle members extending from said inner side towards said outer side.

5. The multiple child shopping cart extension of claim 1, the side rail portions being connected at the top end on the inner side by an upper horizontal rail portion.

6. The multiple child shopping cart extension of claim 1, further comprising at least two wheel members, affixed to said solid frame structure at said bottom end.

7. The multiple child shopping cart extension of claim 1, further comprising a safety strap, said safety strap being releasably or permanently attached to each of the vertical rail portions on the outer side.

8. The multiple child shopping cart extension of claim 1, said shopping cart frame comprising a basket portion with a generally horizontal bottom surface.

9. The multiple child shopping cart extension of claim 8, further comprising a seat unit, positioned on a slide-out c-channel track, said seat unit being sized and configured to connect to the generally horizontal bottom surface of the basket portion.

10. The further of claim 8, wherein the basket portion is a one-tier basket portion.

11. The further of claim 8, wherein the basket portion is a two-tier basket portion.

12. A method of assembling an extended shopping cart with the multiple child shopping cart extension of claim 1, the method comprising:
securing, with the frame securing elements, the multiple child shopping cart extension to the shopping cart frame.

13. The method of claim 12, the method further comprising: securing a seat unit, positioned on a slide-out c-channel track, to a generally horizontal bottom surface of a basket portion of said shopping cart frame.

14. The method of claim 12, wherein the multiple child shopping cart extension is releasably secured to said shopping cart frame.

15. The method of claim 12, wherein the multiple child shopping cart extension is permanently secured to said shopping cart frame.

16. A kit for assembling an extended shopping cart with the multiple child shopping cart extension of claim 1, the kit comprising: the frame securing elements, the multiple child shopping cart extension, and two or more wheel members.

17. The kit of claim 16, further comprising a seat unit positioned on a slide-out c-channel track.

18. The kit of claim 16, further comprising a safety strap.
